(19) United States
(12) Patent Application Publication
(10) Pub. No.: US 2026/0196381 A1
(43) Pub. Date: Jul. 9, 2026

(54) WIRING HARNESS AND WIRING HARNESS MANUFACTURING METHOD

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Takuya YAMASHITA, Mie (JP); Yutaka TAKATA, Mie (JP)

(21) Appl. No.: 19/131,216

(22) PCT Filed: Nov. 28, 2023
(86) PCT No.: PCT/JP2023/042438

§ 371 Date: May 20, 2025

(30) Foreign Application Priority Data
Nov. 30, 2022 (JP) 2022-191448

(51) Int. Cl. H01B 7/285; H01B 7/00; H01B 13/012; H02G 15/18

(52) U.S. Cl. CPC H01B 7/285; H01B 7/0045; H01B 13/01209; H02G 15/18

(57) ABSTRACT

Provided are a wire harness in which leakage from a sheet body of a resin composition constituting a waterproof portion is reduced, and that can ensure a high waterproofing property, and a method for manufacturing the same. A splice portion 5 joins together electric wires 4, which constitute an electric wire bundle 2, in an exposed portion 21 in which a conductor 41 is exposed. A waterproof portion 6 coats the splice portion and a coated portion 22 with a curable resin material, in which coated portion 22 the exposed portion and the conductor are coated with an insulating coating 42. A sheet body 7 surrounds the outer periphery of the waterproof portion. The waterproof portion in the exposed portion fills a space between the plurality of the electric wires constituting the electric wire bundle with the resin material without a gap, and includes, in an area thereof that is surrounded by the sheet body and that coats the coated portion, an end region 61 which is a partial region including an end part, and an adjacent region 62 adjacent to the end region along the axis direction of the electric wire bundle. The waterproof portion has a smoother surface in the end region than in the adjacent region.

### TECHNICAL FIELD

The present disclosure relates to a wiring harness and a wiring harness manufacturing method.

### BACKGROUND

In a wiring harness including a plurality of wires, conductors exposed from insulation coatings of the respective wires may be joined to each other using a crimping terminal or the like to form a splice portion. Such a wiring harness provided with a splice portion is, for example, disclosed in Patent Documents 1 to 3. In those wiring harnesses provided with the splice portion, a part including the splice portion may be covered with a waterproof portion made of a resin material impermeable to water for the purpose of protecting the splice portion from contact with water. Patent Documents 1 and 2 disclose a wiring harness in which a waterproof portion is configured by covering a region including a splice portion by a resin material and a sheet body is provided to surround the outer periphery of the waterproof portion. Such a structure can be easily formed by arranging a photo-curable resin composition on a surface of the sheet body transmitting light, placing regions including a splice portion of a wiring harness on that resin composition, surrounding those regions by a sheet body having the resin composition thereon and irradiating light from the outside of the sheet body to cure the resin composition.

### PRIOR ART DOCUMENT

### Patent Document

Patent Document 1: JP 2012-248527 A
Patent Document 2: JP 2021-034188 A
Patent Document 3: JP H01-154473 A

### SUMMARY OF THE INVENTION

### Problems to be Solved

If a liquid resin composition is arranged on a sheet body, regions including a splice portion of a wiring harness are surrounded by that sheet body and, then, the resin composition is cured as disclosed in Patent Documents 1 and 2, a waterproof portion can be easily formed on the outer periphery of the splice portion. However, in this case, in a step of surrounding the regions including the splice portion of the wiring harness by the sheet body, such as by bending or winding the sheet body having the liquid resin composition arranged thereon, the resin composition easily leaks to the outside of the sheet body according to those operations. If the leakage of the resin composition occurs, workability is reduced in the following step of forming the waterproof portion. Further, if the leaked resin composition is cured as it is, there is a possibility that the resin composition cured outside the sheet body gives unfavorable influences such as contact with a surrounding object in the completed wiring harness.

If a waterproof portion is configured using a highly viscous resin composition like a jelly-like sealant disclosed in Patent Document 3, the leakage of the resin composition from a sheet body can be suppressed in various operation steps. However, in the case of using the highly viscous resin composition, the resin composition may not sufficiently spread to each part in a region where the waterproof portion should be formed, including a location among a plurality of wires joined by a splice portion, and gaps not occupied by the resin composition may possibly remain inside the waterproof portion. If such gaps are formed, water intrusion into the waterproof portion is allowed and sufficient waterproofness is not possibly obtained.

In view of the above, it is aimed to provide a wiring harness, in which a waterproof portion is provided on the outer periphery of a splice portion and the outer periphery of the waterproof portion is surrounded by a sheet body and which can reduce the leakage of a resin composition constituting the waterproof portion from the sheet body and ensure high waterproofness, and a method for manufacturing such a wiring harness.

### Means to Solve the Problem

A wiring harness of the present disclosure is provided with a wire bundle, a splice portion, a waterproof portion and a sheet body, the wire bundle including a plurality of wires, the wire including a conductor and an insulation coating covering an outer periphery of the conductor, the wire bundle including an exposed portion where the conductors are exposed from the insulation coatings of the wires and a covering portion adjacent to the exposed portion, the conductors being covered by the insulation coatings in the covering portion, the splice portion joining the wires constituting the wire bundle to each other in the exposed portion, the waterproof portion covering the splice portion, the exposed portion and the covering portion by a curable resin material, the sheet body surrounding an outer periphery of the waterproof portion, the waterproof portion filling a space between the plurality of wires constituting the wire bundle without any gap by the resin material in the exposed portion, and the waterproof portion including a partial region having an end part as an end region and a region adjacent to the end region as an adjacent region, out of a region surrounded by the sheet body and covering the covering portion along an axial direction of the wire bundle, the waterproof portion having a smoother surface in the end region than in the adjacent region.

A wiring harness manufacturing method of the present disclosure is provided with a joining step of forming a wire bundle by bundling a plurality of wires each including a conductor and an insulation coating covering an outer periphery of the conductor after the insulation coatings in a partial region are removed, the wire bundle including an exposed portion where the conductors are exposed and a covering portion adjacent to the exposed portion, the conductors being covered by the insulation coatings in the covering portion, forming a splice portion by joining the wires to each other in the exposed portion and fabricating a harness precursor, a resin arranging step of arranging a curable liquid resin composition in a partial region of a surface of a sheet body, a partial viscosity increasing step of increasing a viscosity of the resin composition arranged on the surface of the sheet body only in a partial region to form a high viscosity region and leave a region other than the high viscosity region as a liquid region, a harness arranging step of arranging a part including the splice portion of the harness precursor on a surface of the resin composition so that the exposed portion of the wire bundle contacts the liquid region, a surrounding step of surrounding the harness precursor by the surface of the sheet body having the resin composition arranged thereon, and a curing step of curing the resin composition surrounded by the sheet body in an entire region, the joining step, the resin arranging step, the partial viscosity increasing step, the harness arranging step, the surrounding step and the curing step being performed in this order, and, in the partial viscosity increasing step, the high viscosity regions being provided in a first part and a second part respectively including one end part and another end part and separated from each other along an axial direction of the harness precursor, out of the region where the resin composition is arranged, and the liquid region being provided between the first part and the second part to include a region where the exposed portion of the wire bundle is arranged.

### Effect of the Invention

The wiring harness according to the present disclosure is a wiring harness, in which a waterproof portion is provided on the outer periphery of a splice portion and the outer periphery of the waterproof portion is surrounded by a sheet body and which can reduce the leakage of a resin composition constituting the waterproof portion from the sheet body and ensure high waterproofness. Further, according to a wiring harness manufacturing method according to the present disclosure, such a wiring harness can be manufactured.

### BRIEF DESCRIPTION OF THE DRAWINGS

FIG. 1 is a perspective view showing a wiring harness according to one embodiment of the present disclosure.

FIG. 2 is a schematic section showing the wiring harness.

FIGS. 3A to 3C are diagrams showing a wiring harness manufacturing method using a partial semi-curing method, wherein FIG. 3A shows a harness precursor obtained in a joint step, FIG. 3B shows a resin arranging step, FIG. 3C shows a partial viscosity increasing step, an uncured resin composition is shown by hatching and a resin material in a semi-cured state is shown by crosshatching in FIGS. 3A to 3C.

FIGS. 4A to 4C are diagrams showing subsequent steps of the wiring harness manufacturing method, wherein FIG. 4A shows a harness arranging step, FIG. 4B shows a step of bending the sheet body in a surrounding step, FIG. 4C shows a step of squeezing the sheet body in the surrounding step and only FIG. 4A shows a plan view.

FIG. 5 is a diagram showing a curing step as a subsequent step of the wiring harness manufacturing method.

FIGS. 6A to 6F are diagrams showing the structures of wiring harnesses manufactured by three types of manufacturing methods, wherein FIGS. 6A to 6C enlargedly show a state near an end part of a waterproof portion (sections along A-A of FIG. 1) and FIGS. 6D to 6F show a state in a region corresponding to an exposed portion of a wire bundle (sections along B-B of FIG. 1) for the wiring harnesses respectively manufactured by a partial semi-curing method, a one-stage curing method and an entire semi-curing method.

FIG. 7 is a picture obtained by enlarging and photographing the vicinity of an end part of a covering portion of a wire constituting a wire bundle in the wiring harness manufactured by the partial semi-curing method.

### DETAILED DESCRIPTION TO EXECUTE THE INVENTION

### Description of Embodiments of Present Disclosure

First, embodiments of the present disclosure are listed and described.
(1) The wiring harness of the present disclosure is provided with a wire bundle, a splice portion, a waterproof portion and a sheet body, the wire bundle including a plurality of wires, the wire including a conductor and an insulation coating covering an outer periphery of the conductor, the wire bundle including an exposed portion where the conductors are exposed from the insulation coatings of the wires and a covering portion adjacent to the exposed portion, the conductors being covered by the insulation coatings in the covering portion, the splice portion joining the wires constituting the wire bundle to each other in the exposed portion, the waterproof portion covering the splice portion, the exposed portion and the covering portion by a curable resin material, the sheet body surrounding an outer periphery of the waterproof portion, the waterproof portion filling a space between the plurality of wires constituting the wire bundle without any gap by the resin material in the exposed portion, and the waterproof portion including a partial region having an end part as an end region and a region adjacent to the end region as an adjacent region, out of a region surrounded by the sheet body and covering the covering portion along an axial direction of the wire bundle, the waterproof portion having a smoother surface in the end region than in the adjacent region.

In the wiring harness in which the waterproof portion is provided on the outer periphery of the splice portion and the waterproof portion is further surrounded by the sheet body, that the waterproof portion has a smoother surface in the end region including the end part than in the adjacent region adjacent to the end region, out of the region surrounded by the sheet body and covering the covering portion of the wire bundle is an evidence showing that the leakage of a resin composition constituting the waterproof portion is reduced and the resin material is densely filled in the space between the wires constituting the wire bundle in the exposed portion in that wiring harness. The reason for that is as described in the next paragraph. By reducing the leakage of the resin composition from the sheet body, a reduction in workability due to the leakage of a large amount of the uncured resin composition to the outside of the sheet body when the waterproof portion is formed is suppressed. Further, the resin material leaked from the sheet body and cured hardly causes influences such as contact with a surrounding object. On the other hand, since the resin material is densely filled in the space between the wires constituting the wire bundle, water intrusion into the waterproof portion is highly suppressed. Thus, the waterproof portion exhibits high waterproofness.

The wiring harness in which the waterproof portion is provided on the outer periphery of the splice portion and the waterproof portion is further surrounded by the sheet body can be formed by curing the resin composition after a part including the splice portion of a harness precursor, in which the plurality of wires are joined by the splice portion, is surrounded by the sheet body having the resin composition arranged thereon. At this time, a method is adopted which surrounds the harness precursor by the sheet body and cures the resin composition after a viscosity of a partial region including both end parts of the harness precursor along the axial direction, out of the resin composition arranged on the surface of the sheet body, is increased in advance to form high viscosity regions, a structure for reducing the leakage of the resin composition constituting the waterproof portion from the sheet body and filling the resin material between the wires constituting the wire bundle without any gap as described above can be easily formed. This is because the resin composition is made difficult to flow out to the outside of the sheet body by an operation of surrounding the harness precursor by the sheet body by forming the high viscosity regions in the both end parts, whereas the resin composition kept at a low viscosity can penetrate also to a narrow region among the plurality of wires constituting the wire bundle at a position between those high viscosity regions. In the case of adopting such a manufacturing method, the resin composition kept at a low viscosity may partially flow beyond the high viscosity regions and may be cured at positions beyond the high viscosity regions. Since the resin composition is cured in close contact with the sheet body in the high viscosity regions, a fine uneven structure of the sheet body is transferred to the surface after curing, whereas a part where the resin composition flowed is cured without being held in close contact with the sheet body and, therefore, is hardly affected by the uneven structure of the sheet body and forms a smooth surface. Thus, that the formed waterproof portion has a smoother surface in the end region including the end part than in the adjacent region adjacent to the end region, out of the region surrounded by the sheet body and covering the covering portion is an evidence showing that the waterproof portion was formed by the above method for forming the high viscosity regions by increasing the viscosity of the partial regions of the resin composition in advance, and functions as an index indicating that the waterproof portion was formed with the leakage of the resin composition to the outside of the sheet body reduced and has high waterproofness.

Further, since the end region of the waterproof portion has a smooth surface, water is less likely to adhere or stay in the end part of the waterproof portion as compared to the case where the end region of the waterproof portion has a surface having a low smoothness, and the end region functions to enhance the waterproofness of the waterproof portion. Further, that the end region has a smooth surface indicates that the resin material constituting the waterproof portion is not strongly adhered to the sheet body in the end region. Thus, even if a dynamic load such as bending is applied to the wiring harness in the end region, peeling stress is hardly generated between the waterproof portion and the sheet body and high waterproofness by the waterproof portion is easily maintained even in a situation where a dynamic load is applied. Further, an adhesive area between the waterproof portion and the sheet body is suppressed to be small, and the transfer of substances via an adhesive portion hardly occurs between the waterproof portion and the sheet body. Then, the modification of the resin material and the sheet body due to the transfer of the substances hardly occurs and high waterproofness is maintained even after the use of the wiring harness for a long period of time or in a high-temperature environment.
(2) In the aspect of (1) described above, the waterproof portion may be entirely accommodated inside the region surrounded by the sheet body. In this case, the resin composition constituting the waterproof portion does not leak to the outside of the sheet body and influences possibly caused by the leakage of the resin material such as a reduction in workability at the time of forming the waterproof portion and the contact of the resin material cured outside the sheet body and a surrounding object are eliminated.
(3) In the aspect of (1) or (2) described above, the sheet body may be made of a resin material containing a plasticizer, and the resin material constituting the waterproof portion may either contain no plasticizer or contain a plasticizer at a lower concentration than the sheet body. By containing the plasticizer in the sheet body, the sheet body can be flexibly bent and arranged on the outer periphery of the waterproof portion. On the other hand, since the sheet body contains the plasticizer, the transfer of the plasticizer from the sheet body to the waterproof portion easily occurs. If the transfer of the plasticizer to the waterproof portion occurs, the adhesion of the waterproof portion to the wires and the sheet body is reduced and there is a possibility that sufficient waterproofness of the waterproof portion cannot be maintained. However, in the wiring harness of the present disclosure, the end region of the waterproof portion is not strongly adhered to the sheet body and the adhesive area between the waterproof portion and the sheet body is suppressed to be small as indicated by having the smooth surface, wherefore the transfer of the plasticizer from the sheet body to the waterproof portion hardly occurs. Therefore, a reduction in waterproofness due to the transfer of the plasticizer hardly occurs even after the use of the wiring harness for a long period of time or in a high-temperature environment.
(4) In the aspect of any one of (1) to (3) described above, in the waterproof portion, the adjacent region may continuously extend at least to a region covering the splice portion and the end region may have a smoother surface than the entire adjacent region. As described above, the adjacent region having a surface having a low smoothness is a region where the resin composition is cured in close contact with the sheet body, and exhibits high waterproofness by being held in close contact with the sheet body. Since such an adjacent region exhibiting high waterproofness is formed to include the region covering the splice portion, the wiring harness is excellent in waterproofness.
(5) In the aspect of (4) described above, the wiring harness may include the splice portion as an intermediate splice portion in a midway part in the axial direction and include the wire bundle as a first wire portion on one side of the splice portion along the axial direction and a second wire portion having one or more wires on the other side, and the waterproof portion may cover a region from the covering portion of the first wire portion to the covering portion of the second wire portion and include the end region at least in a partial region including an end part on the side of the first wire portion. Then, high waterproofness can be given to the entire intermediate splice portion by the waterproof portion. By curing the resin composition after the curable resin composition is arranged on the surface of the sheet body, a harness precursor formed with the intermediate splice portion is placed on the resin composition and, then, the region including the intermediate splice portion is surrounded by the sheet body, an intermediate part of the wiring harness can be easily waterproofed. At this time, by adopting a method for forming the high viscosity regions in the both end parts of the resin composition along the axial direction of the harness precursor, the formation of the end regions having a low surface smoothness being given as an evidence of the formation of the high viscosity regions, the waterproofness of the intermediate splice portion can be easily and highly achieved by reducing the leakage of the resin composition from the sheet body. If the second wire portion includes only one wire, the end region having a smooth surface may not be provided in the end part on the side of the second wire portion. However, if the second wire portion is configured as a wire bundle including a plurality of wires, the end region having a smooth surface is preferably provided in the end part on the side of the second wire portion, similarly to the end part on the side of the first wire portion.
(6) The wiring harness manufacturing method of the present disclosure is provided with a joining step of forming a wire bundle by bundling a plurality of wires each including a conductor and an insulation coating covering an outer periphery of the conductor after the insulation coatings in a partial region are removed, the wire bundle including an exposed portion where the conductors are exposed and a covering portion adjacent to the exposed portion, the conductors being covered by the insulation coatings in the covering portion, forming a splice portion by joining the wires to each other in the exposed portion and fabricating a harness precursor, a resin arranging step of arranging a curable liquid resin composition in a partial region of a surface of a sheet body, a partial viscosity increasing step of increasing a viscosity of the resin composition arranged on the surface of the sheet body only in a partial region to form a high viscosity region and leave a region other than the high viscosity region as a liquid region, a harness arranging step of arranging a part including the splice portion of the harness precursor on a surface of the resin composition so that the exposed portion of the wire bundle contacts the liquid region, a surrounding step of surrounding the harness precursor by the surface of the sheet body having the resin composition arranged thereon, and a curing step of curing the resin composition surrounded by the sheet body in an entire region, the joining step, the resin arranging step, the partial viscosity increasing step, the harness arranging step, the surrounding step and the curing step being performed in this order, and, in the partial viscosity increasing step, the high viscosity regions being provided in a first part and a second part respectively including one end part and another end part and separated from each other along an axial direction of the harness precursor, out of the region where the resin composition is arranged, and the liquid region being provided between the first part and the second part to include a region where the exposed portion of the wire bundle is arranged.

In this wiring harness manufacturing method, the high viscosity regions are formed by increasing the viscosity of the liquid resin composition arranged on the surface of the sheet body only in the regions located on the both ends along the axial direction of the harness precursor and the liquid region not increased in viscosity is left between those regions in the partial viscosity increasing step. Then, the resin composition is cured in the entire region in the curing step after the harness precursor is so arranged on that resin composition that the exposed portion of the wire bundle contacts the liquid region in the harness arranging step and the harness precursor is surrounded by the sheet body in the surrounding step. By providing the high viscosity regions having a high viscosity of the resin composition in the both end parts of the resin composition on the sheet body, the resin material hardly leaks to the outside of the sheet body due to its fluidity in the surrounding step. This is because the resin composition in the high viscosity regions hardly flows by having a high viscosity and, moreover, even if the resin composition in the liquid region flows, the resin composition hardly leaks to the outside of the sheet body by being sandwiched on both sides by the high viscosity regions. On the other hand, since the resin composition in the liquid region keeping a fluid state contacts the exposed portion of the wire bundle, the resin material easily penetrates to a space between the respective wires without any gap in the exposed portion. In this way, it is possible to form the waterproof portion for reducing the leakage of the resin material to the outside of the sheet body by way of curing the entire region of the resin composition in the curing step and exhibiting high waterproofness by filling the space between the plurality of wires without any gap by the resin material in the exposed portion. In performing the surrounding step, the resin composition in the liquid region possibly stays in the region between the high viscosity regions or flows beyond the high viscosity region. In the latter case, the wiring harnesses of (1) to (5) described above are obtained in which the waterproof portion is formed with the end region having a smoother surface than the adjacent region.
(7) In the aspect of (6) described above, the resin composition may be photo-curable, the sheet body may be transmissive to light capable of curing the resin composition, light may be irradiated to the resin composition with a region to be set as the liquid region, out of the resin composition arranged on the surface of the sheet body, covered by a mask member for blocking the light in the partial viscosity increasing step, whereby the resin composition is semi-cured in the high viscosity regions, and light may be irradiated to the entire region of the resin composition to cure the resin composition from outside of the sheet body surrounding the harness precursor in the curing step. In this case, by using the mask member and irradiating light with a cumulative light amount suppressed not to completely cure the resin composition in the viscosity increasing step, the resin composition in locations where the high viscosity regions should be formed can be easily selectively brought into a semi-cured state and a state where the high viscosity regions and the liquid region coexist to occupy a predetermined region can be formed. Further, by making a cumulative light amount per area larger in the curing step than in the viscosity increasing step and irradiating light from the outside of the sheet body to cure the resin material in the entire region, the waterproof portion exhibiting high waterproofness can be easily formed.
(8) In the aspect of (6) or (7) described above, the sheet body may be made of a resin material containing a plasticizer, and the resin composition may either contain no plasticizer or contain a plasticizer at a lower concentration than the sheet body. Then, the flexibility of the sheet body is enhanced by containing the plasticizer, and the sheet body can be flexibly arranged on the outer periphery of a predetermined location of the harness precursor in the surrounding step. In the manufactured wiring harness, there is a possibility that the plasticizer transfers from the sheet body to the waterproof portion via a location where the sheet body and the waterproof portion are firmly adhered. However, by increasing the viscosity of the regions in the both ends of the resin composition to form the high viscosity regions in the partial viscosity increasing step, the liquid resin composition hardly spreads to a region having a large area in the subsequent surrounding step. Thus, an area of an adhesive portion formed between the waterproof portion and the sheet body by way of the curing step is suppressed to be small, and a transfer amount of the plasticizer to the waterproof portion via the adhesive portion is suppressed to be small. Therefore, in the manufactured wiring harness, the transfer of the plasticizer from the sheet body to the waterproof portion hardly occurs even after use for a long period of time or in a high-temperature environment, and a reduction in adhesion between the waterproof portion and the wires and the sheet body due to the transfer of the plasticizer is suppressed, with the result that high waterproofness is maintained.
(9) In the aspect of any one of (6) to (8) described above, the harness precursor may include the splice portion as an intermediate splice portion in a midway part in the axial direction and include the wire bundle as a first wire portion on one side of the splice portion along the axial direction and a second wire portion having one or more wires on the other side, the resin composition may be continuously arranged at a position corresponding to a region from the covering portion of the first wire portion to the covering portion of the second wire portion of the harness precursor in the resin arranging step, the first part may be provided in a region corresponding to a part of the covering portion of the first wire portion and the second part may be provided to include a region corresponding to a part of the covering portion of the second wire portion as the high viscosity regions in the partial viscosity increasing step. In this case, the waterproof portion can be easily formed even in the midway part of the wiring harness by arranging the resin composition on the surface of the sheet body and curing the resin composition after the splice portion is surrounded by the sheet body. By providing the high viscosity regions to include locations on the both ends along the axial direction of the harness precursor, out of the resin composition, in the partial viscosity increasing step, the resin composition hardly flows out from the both ends of the sheet body in the subsequent surrounding step. Therefore, high workability is obtained in waterproofing the intermediate splice portion.
(10) In the aspect of (9) described above, the second wire portion may include only one wire, and the second part may be continuously provided in a region corresponding to a location from the splice portion to the covering portion of the second wire portion in the partial viscosity increasing step. If the second wire portion includes only one wire, the location where the liquid region is left in the partial viscosity increasing step only needs to be a region closer to the first wire portion than the splice portion for the purpose of filling the resin material between the wires without any gap. On the side of the second wire portion, the high viscosity region can be continuously provided in a region from the splice portion to the covering portion of the second wire portion. By increasing a ratio of the high viscosity regions and decreasing a ratio of the liquid region in this way, the outflow of the liquid resin composition from the sheet body can be highly suppressed.

### DETAILS OF EMBODIMENT OF PRESENT DISCLOSURE

A wiring harness and a wiring harness manufacturing method according to an embodiment of the present disclosure are described in detail with reference to the drawings. The wiring harness according to the embodiment of the present disclosure includes a splice portion formed by joining a plurality of wires and a waterproof portion for covering a region including the splice portion. Such a wiring harness can be manufactured by the wiring harness manufacturing method according to the embodiment of the present disclosure.

### <Summary of Wiring Harness>

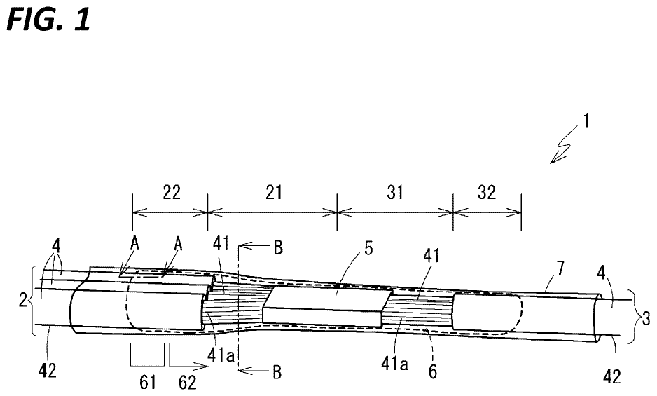

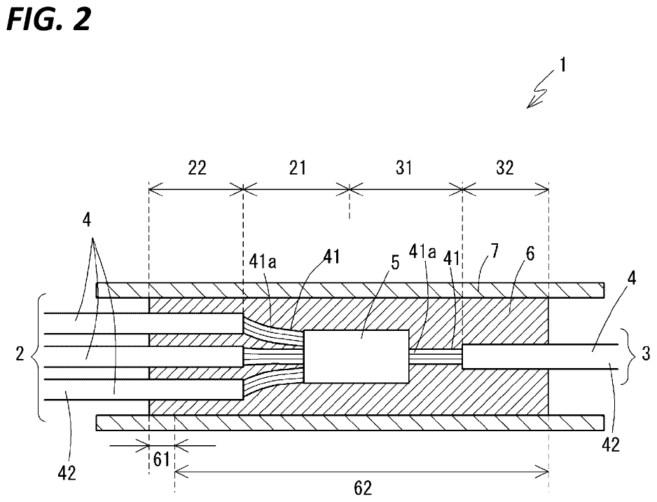

First, the structure of the wiring harness according to the embodiment of the present disclosure is summarized. The wiring harness 1 according to the embodiment of the present disclosure is schematically shown in FIGS. 1 and 2. FIG. 1 is a perspective view and FIG. 2 is a schematic section. FIG. 2 schematically shows a cross-section along an axial direction of the wiring harness 1 and shows wires 4 and a splice portion 5 without being cut.

The wiring harness 1 includes a first wire portion 2 and a second wire portion 3. The first wire portion 2 includes a plurality of the wires 4, and the second wire portion 3 includes one or more wires 4. In a shown form, the first wire portion 2 includes three wires 4. The second wire portion 3 includes only one wire 4.

Each of the wires 4 constituting the first and second wire portions 2, 3 includes a conductor 41 and an insulation coating 42 covering the outer periphery of the conductor 41. In each wire 4, the insulation coating 42 is removed in a partial region in an axial direction to expose the conductor 41. In the first and second wire portions 2, 3, parts where those conductors 41 are exposed respectively serve as exposed portions 21, 31. Further, parts, which are adjacent to those exposed portions 21, 31 and in which the conductors 41 of the respective wires 4 are covered by the insulation coatings 42, serve as covering portions 22, 32. In the wiring harness 1 according to this embodiment, one (e.g. middle one) of the wires 4 constituting the first wire portion 2 is one wire (main wire) continuous with one wire 4 constituting the second wire portion 3, and the insulation coating 42 is removed in an intermediate part of that main wire to expose the conductor 41. Conductor exposed portions formed in end parts of the other wires 4 (branch wires) constituting the first wire portion 2 are joined to a conductor exposed portion formed in the intermediate part of that main wire by the splice portion 5 to be described next.

The splice portion 5 is formed between the first and second wire portions 2, 3. In the splice portion 5, the respective wires 4 constituting the first and second wire portions 2, 3 are joined to each other in the exposed portions 21, 31. In the shown form, the conductors 41 of the respective wires 4 are joined by crimping and fixing using a crimping terminal in the splice portion 5. Note that, in the splice portion 5, if the conductors 41 of the respective wires 4 are electrically connected and physically fixed to each other, the conductors 41 may be joined by any means. Besides the use of the crimping terminal, welding such as resistance welding or ultrasonic welding and joining using molten metal such as soldering can be illustrated. In the shown form, the splice portion 5 is formed as an intermediate splice portion in a midway part along the axial direction of the wiring harness 1. That is, the first and second wire portions 2, 3 extend in different directions across the splice portion 5. The splice portion 5 joins two branch wires constituting the first wire portion 2 to one main wire continuous from the first wire portion 2 to the second wire portion 3.

The wiring harness 1 further includes a waterproof portion 6 covering a region including the splice portion 5 by a resin material. The resin material constituting the waterproof portion 6 covers the splice portion 5, the exposed portion 21 and the covering portion 22 of the first wire portion 2 and the exposed portion 31 and the covering portion 32 of the second wire portion 3. That is, the waterproof portion 6 seamlessly and continuously covers a region from the covering portion 22 of the first wire portion 2 to the covering portion 32 of the second wire portion 3 over an entire periphery. The waterproof portion 6 functions as a waterproof member for suppressing the intrusion of water (including an electrolyte; the same shall apply hereinafter) into the splice portion 5.

Further, the wiring harness 1 is provided with a sheet body 7. The sheet body 7 surrounds the outer periphery of the waterproof portion 6. By providing the sheet body 7 in the wiring harness 1, the waterproof portion 6 can be easily formed as described for the manufacturing method of the wiring harness 1 later. Further, the sheet body 7 also functions as a protecting member for protecting the waterproof portion 6 from contact with an external object or the like. In the shown form, the waterproof portion 6 is entirely accommodated inside a region surrounded by the sheet body 7. That is, the resin material constituting the waterproof portion 6 does not leak to the outside of the sheet body 7.

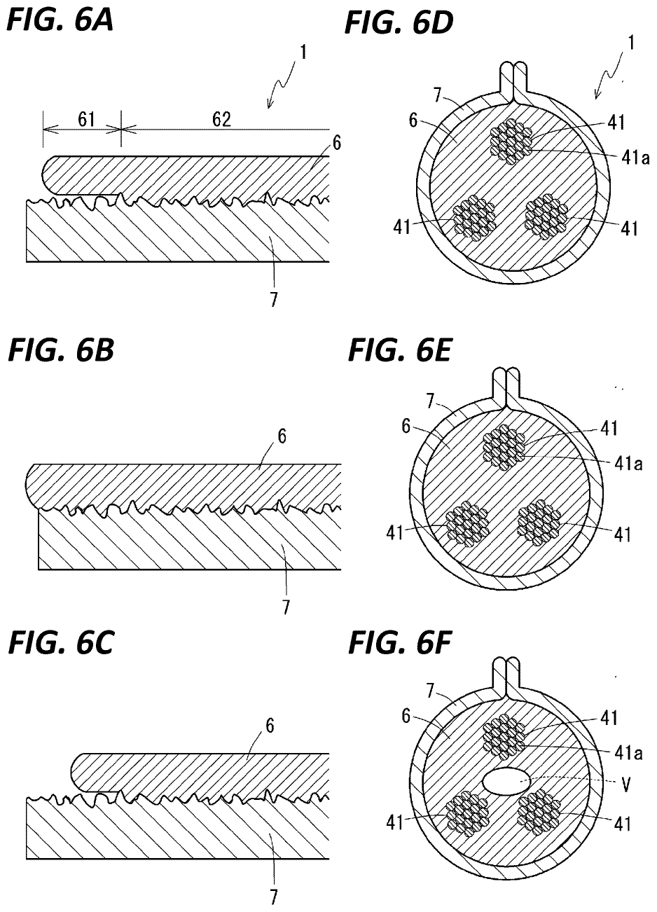

The waterproof portion 6 covers the outer periphery of a region including the two wire portions 2, 3 and the splice portion 5 in the wiring harness 1 and, in addition, the resin material constituting the waterproof portion 6 enters spaces between constituent members of the wiring harness 1 and fills those spaces in the wire portions 2, 3 and the splice portion 5. Particularly, in the wiring harness 1 according to this embodiment, the waterproof portion 6 fills a space between the respective wires 4 constituting a wire bundle of the first wire portion 2 without any gap by the resin material at least in the exposed portion 21 as shown in a section of FIG. 6D at the position of the exposed portion 21 of the first wire portion 2. Here, a state where the space between the respective wires 4 is filled by the resin material without any gap means not only a state where a space unoccupied by the resin material is not present at all, but also a state where gaps having a cross-sectional area, which is 10% or less of a conductor cross-sectional area of each wire 4, more strictly, gaps having a cross-sectional area, which is 1% or less of the conductor cross-sectional area of each wire 4, are basically present. Preferably, in the wire bundle of the first wire portion 2, the space between the wires 4 may be filled without any gap by the resin material in a region including not only the exposed portion 21, but also at least a part of the covering portion 22, and further the entire region surrounded by the waterproof portion 6.

In the wiring harness 1 according to this embodiment, an end region 61 and an adjacent region 62 are present adjacent to each other along the axial direction of the first wire portion 2, and those end region 61 and adjacent region 62 are identified from each other by a surface state. Specifically, the end region 61 is a partial region along the axial direction of the first wire portion 2 including an end part on the side of the first wire portion 2, out of a region where the waterproof portion 6 is surrounded by the sheet body 7 and covers the first wire portion 2. The adjacent region 62 is provided as a region adjacent to the end region 61, and formed as a region including parts other than the end region 61, out of the region where the waterproof portion 6 is surrounded by the sheet body 7 and covers the first wire portion 2. As shown in an enlarged section of FIG. 6A near an end part of the waterproof portion 6, the end region 61 has a smoother surface than the adjacent region 62 in the waterproof portion 6, focusing on the surface (surface on the side of the sheet body 7) of the waterproof portion 6 having the sheet body 7 removed therefrom. That is, the end region 61 has a surface having a low roughness than the adjacent region 62, and a height difference and/or a density of an uneven structure of the surface are/is low. Causes and properties of such an end region 61 are described in detail later.

In the shown form, in the waterproof portion 6, the adjacent region 62 continuously extends from a part except the end region 61, out of the region covering the covering portion 22 of the first wire portion 2, to a region covering the splice portion 5 and further extends to a region covering the covering portion 32 of the second wire portion 3, thereby continuously covering the region from the covering portion 22 of the first wire portion 2 to the covering portion 32 of the second wire portion 3. The end region 61, which is a region including the end part of the waterproof portion 6 on the side of the first wire portion 2, has a smoother surface than the entire end region 62 occupying a wider region. Here, the adjacent region 62 is provided to reach the end part of the waterproof portion 6 on the side of the second wire portion 3. Besides this form, an end region 61 occupying a part of a region where the waterproof portion 6 is surrounded by the sheet body 7 and covers the covering portion 32 may be provided also in a region including the end part of the waterproof portion 6 on the side of the second wire portion 3 and have a smoother surface than the adjacent region 62, similarly to the end region 61 on the side of the first wire portion 2. In the latter case, the adjacent region 62 having a low surface smoothness is provided between two end regions 61 having the smooth surface.

Since the waterproof portion 6 has the smoother surface in the end region 61 than in the adjacent region 62, adhesion between the waterproof portion 6 and the sheet body 7 is lower in the end region 61 than in the adjacent region 62. In this case, the waterproof portion 6 is typically strongly adhered to the sheet body 7 in the adjacent region 62. However, in the end region 61, the waterproof portion 6 is not adhered to the sheet body 7 or adhesive strength is weaker than in the adjacent region 62 even if the waterproof portion 6 is adhered.

Materials for constituting the respective components of the wiring harness 1 are not particularly limited, but suitable materials and the like are illustrated below. The conductor 41 constituting the wire 4 may be constituted by a single wire, but is preferably constituted by an aggregate of a plurality of strands 41a. A metal material for constituting the strands 41a is not particularly limited, and copper, copper alloy, aluminum, aluminum alloy and the like can be illustrated. The conductor 41 may be composed of one type of strands 41a or may include two or more types of strands 41a. Further, the conductor 41 may include strands made of a material other than the metal material such as organic fibers, in addition to the metal strands 41a. The insulation coating 42 constituting the wire 4 is made of an insulating polymer material. Polyolefins such as polypropylene (PP), halogen-based polymers such as polyvinyl chloride (PVC), thermoplastic elastomers, rubbers and the like can be cited as a specific polymer material. These polymer materials may be singly used to constitute the insulation coating 42 or two or more types of these may be mixed. Various additives may be added to the polymer material as appropriate. Flame retardants, fillers, colorants and the like can be cited as an additive.

The waterproof portion 6 is made of a curable resin material. That is, the resin material for constituting the waterproof portion 6 is a cured material of a curable resin composition. The type of the curability of the resin material is not particularly limited, and a curable resin materials having arbitrary curability can be used depending on various phenomena such as photocurability, thermal curability, moisture curability, two-component reaction curability and dry curability (curability by the evaporative drying of a solvent). The resin material may have two or more types of curability. However, the resin material for constituting the waterproof portion 6 preferably has photocurability, particularly ultraviolet curability from the perspective of facilitating a curing operation in forming the waterproof portion 6 and a viscosity adjusting operation in a partial viscosity increasing step to be described later.

The resin type of the resin material for constituting the waterproof portion 6 is also not particularly limited, but silicone-based resins, acrylic-based resins, epoxy-based resins, urethane-based resins, cyanoacrylate-based resins and the like can be illustrated. Among these, the use of an acrylic-based resin is suitable. Urethane (meth)acrylate-based resins, epoxy (meth)acrylate-based resins, polyester (meth)acrylate-based resins and the like can be illustrated as a photo-curability acrylic-based resin. Only one type of resin material may be used or two or more types of resin materials may be mixed and used as the resin material for constituting the waterproof portion 6. Further, various additives may be added to the resin material as appropriate. Reaction initiators, flame retardants, fillers, colorants and the like can be cited as an additive.

A material for constituting the sheet body 7 is also not particularly limited and various resin materials can be used. Polyolefins such as polypropylene, halogen-based polymers such as PVC, polyesters such as polyethylene terephthalate, polyamides such as nylon can be illustrated as the resin material. Various additives may be added to the resin material as appropriate. Further, the sheet body 7 may be arranged in a predetermined region of the outer periphery of the splice portion 5 via the waterproof portion 6, and may be configured as an adhesive tape including an adhesive layer having a glue or an adhesive arranged therein in terms of simplicity in fixing. In this case, a surface provided with the adhesive layer is a surface to be held in contact with the waterproof portion 6. Further, if the resin material for constituting the waterproof portion 6 is a photo-curable resin, the sheet body 7 is preferably made of a material transmitting light used to cure the resin material so that the resin material is cured by light irradiation via the sheet body 7. The size of the sheet body 7 is not particularly limited if the sheet body 7 is large enough to cover the outer periphery of the waterproof portion 6, but the sheet body 7 preferably includes excess parts surrounding only the wire portions 2, 3 without surrounding the waterproof portion 6 on both ends along the axial direction of the wiring harness 1.

The sheet body 7 preferably contains a plasticizer. By containing the plasticizer, the flexibility of the sheet body 7 is improved and the sheet body 7 can be arranged on the outer periphery of the predetermined region including the splice portion 5 in the wiring harness 1 by being flexibly bent or curved. Phthalate ester-based plasticizers such as diisononyl phthalate, trimellitic ester-based plasticizers such as tri-2-ethylhexyl trimellicate, aliphatic dibasic acid ester-based plasticizers such as 2-ethylhexycyl adipate and dibutyl sebasicate, epoxy-based plasticizers such as epoxidized soybean oil, phosphate ester-based plasticizers such as tricresyl phosphate and the like can be cited as the plasticizer. If the sheet body 7 includes the adhesive layer, the plasticizer may be also contained in that adhesive layer. On the other hand, if the sheet body 7 contains the plasticizer, the resin material for constituting the waterproof portion 6 preferably contains no plasticizer or contains a plasticizer at a lower concentration than the sheet body 7. Among others, the resin material for constituting the waterproof portion 6 particularly preferably contains no plasticizer.

### <Manufacturing Method of Wiring Harness>

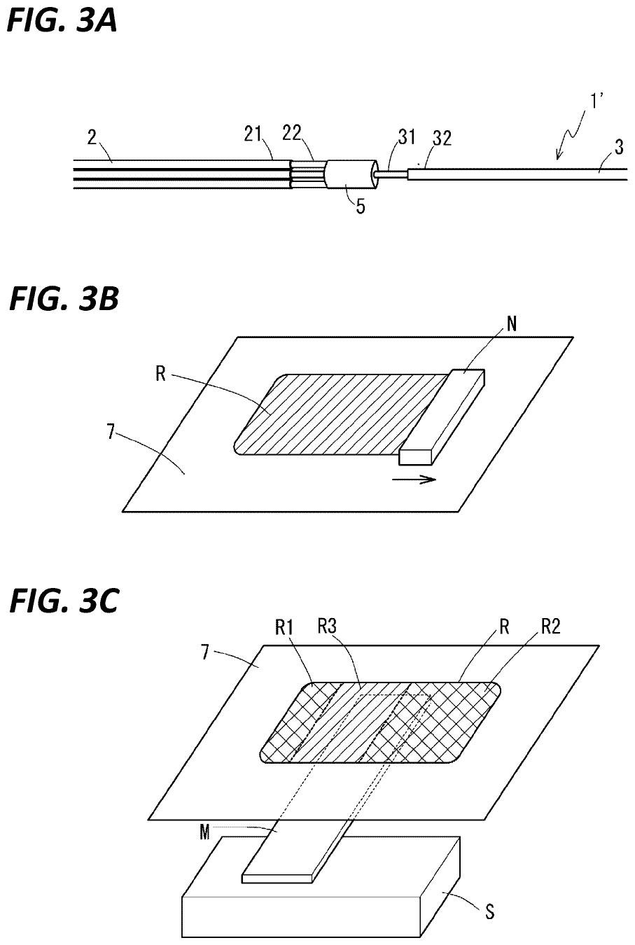

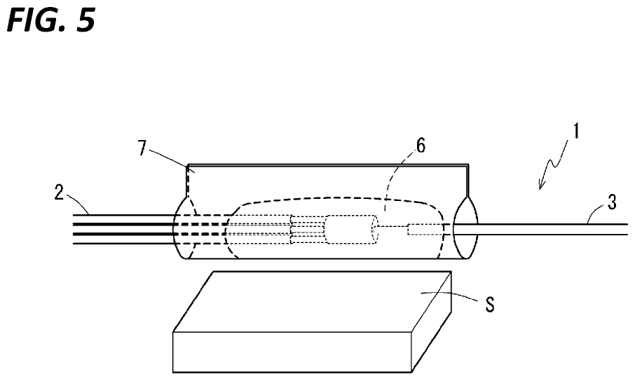

Here, a manufacturing method of the wiring harness according to the embodiment of the present disclosure is described. One form of a wiring harness manufactured by the manufacturing method according to this embodiment is the wiring harness 1 including the end region 61 having the smooth surface in the end part of the waterproof portion 6 described above. The manufacturing method of the wiring harness according to this embodiment uses a partial semi-curing method including the partial viscosity increasing step. Specifically, the wiring harness is manufactured by successively performing (i) joining step, (ii) resin arranging step, (iii) partial viscosity increasing step, (iv) harness arranging step, (v) surrounding step and (vi) curing step. The respective steps are successively described below. The respective steps are schematically shown in FIGS. 3A to 5.

### (i) Joining Step

In the joining steps, the splice portion 5 is formed after the plurality of wires 4 are bundled to form the wire bundle, thereby fabricating a harness precursor 1′ as shown in FIG. 3A. Specifically, a necessary number of the wires 4 cut to a predetermined length are prepared, and the insulation coating 42 is removed in a partial region in the axial direction to expose the conductor 41 in each wire 4. The plurality of wires 4 having the conductors 41 partially exposed are bundled to form the wire bundle. The wire bundle is provided with the exposed portion 21, in which the conductors 41 of the wires 4 are exposed, and the covering portion 22, which is adjacent to the exposed portion 21 and in which the conductors 41 are covered by the insulation coatings 42. The plurality of wires 4 are joined to each other in the exposed portion 21 to form the splice portion 5. In the form shown in FIG. 3A, the harness precursor 1′ including the splice portion 5 in the form of an intermediate splice portion in a midway part in the axial direction is fabricated, and the harness precursor 1′ includes a wire bundle as the first wire portion 2 on one side of the splice portion 5 and the second wire portion 3 including one wire 4 on the other side along the axial direction. In particular, the conductor exposed portion is formed in each of the intermediate part of one main wire and the end parts of the two branch wires, those three wires 4 are bundled and, thereafter, the conductor exposed portions of the respective wires 4 are joined to each other using a joining means such as a crimping terminal, whereby the splice portion 5 is formed and the harness precursor 1′ is obtained.

### (ii) Resin Arranging Step

Subsequently, in the resin arranging step, the sheet body 7 and a resin composition R, which will become the waterproof portion 6, are prepared. Here, as shown in FIG. 3B, the liquid resin composition R having curability is arranged on a surface of the planarly spread sheet body 7. The resin composition R becomes the resin material for constituting the waterproof portion 6 by being cured. If the sheet body 7 includes the adhesive layer, the resin composition R is arranged on a surface of that adhesive layer. In an example shown here, the resin composition R having photocurability is used, and the sheet body 7 transmissive to light capable of curing the resin composition R is used.

In this resin arranging step, the resin composition R is arranged only in a partial region of the surface of the sheet body 7. Particularly, regions where the resin composition R is not arranged are left on both sides along the axial direction (lateral direction in FIG. 3B) of the harness precursor 1′ to be arranged in the harness arranging step later. In particular, in the wiring harness 1 to be manufactured, the resin composition R is arranged in a region, which will become the adjacent region 62, and the other regions are left in a state where the resin composition R is not arranged on the surface of the sheet body 7. At this time, from the perspective of arranging the resin composition R in the entire necessary region with high uniformity, the liquid resin composition R is preferably dropped in spots on the surface of the sheet body 7 and planarly arranged on the surface of the sheet body 7 rather than being spread by the fluidity thereof. For example, preferably, a wide nozzle N capable of discharging the resin composition R to a linear region is used, and the resin composition R is discharged while the nozzle N is moved. In the form shown in FIG. 3B, the resin composition R is discharged while the nozzle N wide in a depth direction of FIG. 3B is moved in a transverse direction as shown by an arrow, whereby the resin composition R is arranged with high uniformity in a substantially rectangular region.

(iii) Partial Viscosity Increasing Step

Subsequently, the partial viscosity increasing step is performed for the resin composition R on the sheet body 7. In the partial viscosity increasing step, as shown in FIG. 3C, viscosity is increased only in partial regions for the resin composition R arranged on the surface of the sheet body 7 to form high viscosity regions R1, R2. A region of the resin composition R other than in the high viscosity regions R1, R2 becomes a liquid region R3, in which the resin composition R remains in a liquid state by having an initial low viscosity when the resin composition R was supplied to the surface of the sheet body 7.

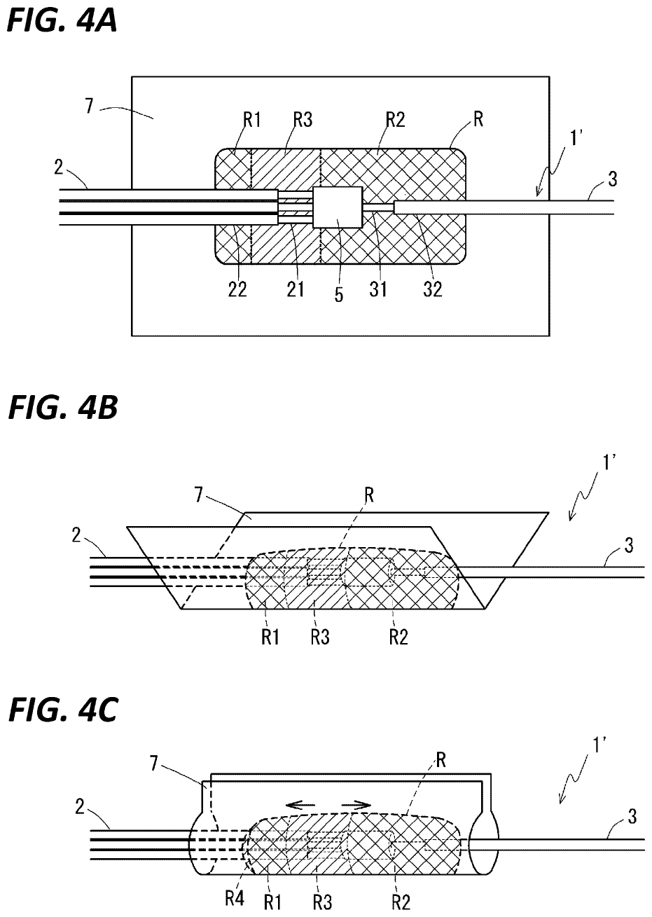

The high viscosity regions are provided in two places including a first part R1 including one end part and a second part R2 including the other end part along the axial direction (transverse direction of FIG. 3C) of the harness precursor 1′ to be arranged in the harness arranging step later, out of the region of the surface of the sheet body 7 where the resin composition R is arranged. The first and second parts R1, R2 are separated from each other. Each of the first and second parts R1, R2 is formed to occupy an entire region where the resin composition R is arranged in a direction (depth direction of FIG. 3C) intersecting the axial direction of the harness precursor 1′. A region between the first and second parts R1, R2 remains as the liquid region R3 where the viscosity of the resin composition R is not increased. The liquid region R3 is formed at a position including a region where the exposed portion 21 of the first wire portion 2 configured as the wire bundle is arranged, out of the harness precursor 1′ to be arranged on the resin composition R in the next harness arranging step (see FIG. 4A). In particular, the first part R1 of the high viscosity region is provided in a region corresponding to a part of the covering portion 22 of the first wire portion 2, out of the harness precursor 1′. More particularly, the first part R1 is provided at a position slightly separated toward the covering portion 22 from a boundary between the exposed portion 21 and the covering portion 22 of the first wire portion 2. Further, the second part R2 is continuously provided in a region corresponding to a location including from the covering portion 32 of the second wire portion 3 to at least a part of the splice portion 5. The liquid region R3 is provided in a location corresponding to a region between those first and second parts R1, R2 and including a part on the side of the exposed portion 21, out of the covering portion 22 of the first wire portion 2, and the exposed portion 21. An area occupied by the high viscosity region is preferably larger in the second part R2 than in the first part R1. For example, a width (dimension in the transverse direction of FIG. 3C) of the second part R2 may be 2-5 times of that of the first part R1.

In the high viscosity region R1, R2, the viscosity of the resin composition R is increased, but the resin composition R is not completely cured and is in a semi-cured state. That is, the resin composition R does not become solid, but becomes a mucous or gel-like substance keeping viscosity. In the high viscosity region R1, R2, the resin composition R holds a viscous state in an entire region in a thickness direction. To increase the viscosity of the curable resin composition R and set the resin composition R in the semi-cured state, an operation capable of curing the resin composition R may be lightly performed to such an extent as not to completely cure the resin composition R according to the curability of the resin composition R. If the resin composition R is photo-curable, the viscosity of the resin composition R can be increased by irradiating light to the resin composition R. A cumulative light amount per unit area may be suppressed to be low in such a range where the resin composition R is not completely cured. In such a range, the viscosity of the resin composition R can be increased as the cumulative light amount per unit area is increased.

To increase the viscosity selectively only in the partial regions to form the high viscosity regions R1, R2 in the resin composition R planarly arranged on the surface of the sheet body 7, the operation for curing may be lightly performed to such an extent as not to completely cure the resin composition R only for the resin composition R in the regions where the high viscosity regions R1, R2 should be formed. If the resin composition R is photo-curable, a mask member M for blocking the irradiated light without transmitting the light may be used. Specifically, in a state where a partial region of the resin composition R, i.e. only the region, which should become the liquid region R3, is covered by the mask member M so that light does not fall on, light is irradiated using a light source device S such as a UV light source. As shown in FIG. 3C, by irradiating light with the region, which will become the liquid region R3, covered by the mask member M, the viscosity of the resin composition R can be increased to form the high viscosity regions R1, R2 in the regions other than the covered region. Light may be irradiated from an arrangement direction of the resin composition R on the surface of the sheet body 7 (from above in FIG. 3C) or may be irradiated to the resin composition R via the sheet body 7 from an arrangement direction of the sheet body 7 (from below in FIG. 3C) as shown. In the latter case, light is easily irradiated in the same arrangement of the light source device S as in the curing step later. The viscosities of the resin composition R in the high viscosity regions R1, R2 and the liquid region R3 are not particularly limited, but the viscosity is, for example, preferably 50 Pa·s or more and 1000 Pa·s or less in the high viscosity regions R1, R2 and less than 5 Pas in the liquid region R3 at room temperature in the atmosphere.

### (iv) Harness Arranging Step

Subsequently, the harness precursor 1′ is arranged on the resin composition R arranged on the surface of the sheet body 7 and formed with the high viscosity regions R1, R2 and the liquid region R3. At this time, as shown in a plan view of FIG. 4A, a part, where the waterproof portion 6 should be formed on the outer periphery, including the splice portion 5 and extending from the covering portion 21 of the first wire portion 2 to the covering portion 32 of the second wire portion 3, out of the harness precursor 1′, is placed on the surface of the resin composition R. In particular, when the harness precursor 1′ is placed on the surface of the resin composition R, a part slightly separated from the boundary with the exposed portion 21, out of the covering portion 22 of the first wire portion 2, is brought into contact with the first part R1 of the high viscosity region. A part including from the covering portion 32 of the second wire portion 3 to at least a part of the splice portion 5 is brought into contact with the second part R2. A location including a part facing the boundary with the exposed portion 21, out of the covering portion 22 of the first wire portion 2, and the entire exposed portion 21 is brought into contact with the liquid region R3. A partial region of the splice portion 5 may also be brought into contact with the liquid region R3.

### (v) Surrounding Step

Subsequently, the surrounding step is performed to cover the part including the splice portion 5 of the harness precursor 1′ arranged on the surface of the resin composition R in the harness arranging step by the surface of the sheet body 7 having the resin composition R arranged thereon. At this time, first as shown in FIG. 4B, the harness precursor 1′ is circumferentially embraced by the sheet body 7 so that the resin composition R arranged on the surface of the sheet body 7 surrounds the splice portion 5, the covering portions 22, 32 and the exposed portions 21, 31 of the two wire portions 2, 3 over the entire periphery, such as by bending or curving the sheet body 7. Further, as shown in FIG. 4C, the sheet body 7 embracing the resin composition R and the harness precursor 1′ inside is squeezed, whereby the resin composition R is evenly spread to each part of the region where the waterproof portion 6 of the harness precursor 1′ should be formed. At this time, the sheet body 7 may be squeezed to narrow a cross-sectional area of the region surrounded by the sheet body 7 (area of a cross-section orthogonal to the axial direction of the harness precursor 1′), thereby eliminating gaps not occupied by the resin composition R as much as possible from a region between the surface of the sheet body 7 and the harness precursor 1′.

In this surrounding step, the resin composition R penetrates also to small and complicated spaces such as gaps between the constituent members and those spaces are occupied by the resin composition R in the harness precursor 1′ particularly by performing the step of squeezing the sheet body 7 as shown in FIG. 4C. A space between the respective wires 4 constituting the first wire portion 2 is also filled by the resin composition R in the exposed portion 21 and further the covering portion 22. Particularly, since the exposed portion 21 of the first wire portion 2 is in contact with the liquid region R3 where the resin composition R is held in a highly fluid state, the resin composition R constituting that liquid region R3 is densely filled in the space between the respective wires 4 without any gap in the exposed portion 21 due to fluidity.

On the other hand, in the regions respectively arranged in contact with the first and second parts R1, R2 of the high viscosity regions, i.e. the region separated from the exposed portion 21, out of the covering portion 22 of the first wire portion 2, and the region from the splice portion 5 to the covering portion 32 of the second wire portion 3, the outer peripheries are surrounded by the resin composition R having a high viscosity. The viscosity of the resin composition R in the high viscosity regions R1, R2 is increased, but the resin composition R is in a viscous state and the fluidity is not completely lost. Therefore, the resin composition R is held in close contact with the outer peripheries of those regions and cover those regions.

By performing the operation of narrowing the cross-sectional area of the region surrounded by the sheet body 7 in this surrounding step, particularly in the step of squeezing the sheet body 7, the resin composition R constituting the liquid region 3 and having a high fluidity tries to flow and spread to both sides in the axial direction of the harness precursor 1′ as indicated by arrows in FIG. 4C. However, in this embodiment, the resin composition R is arranged only in the partial regions of the sheet body 7 in the resin arranging step, a region where the resin composition R is not arranged is present on an outer edge part of the sheet body 7 and, moreover, the high viscosity regions R1, R2 having a low fluidity by increasing the viscosity of the resin composition R are provided on the both sides along the axial direction, out of the region where the resin composition R is arranged, whereby the resin composition R in the liquid region R3 remains inside the region surrounded by the sheet body 7 and hardly flows out to the outside of the sheet body 7 even if the resin composition R flows and spreads. This is because, out of the resin composition R, the regions on the both end parts serve as the high viscosity regions R1, R2 having a low fluidity, the resin composition R itself constituting those high viscosity regions R1, R2 hardly flows and, moreover, the high viscosity regions R1, R2 function as banks to prevent the free flow and spread of the low-viscosity resin composition R in the liquid region R3. By the high viscosity regions R1, R2 acting as the banks, the resin composition R in the liquid region R3 remains in a space between the high viscosity regions R1, R2 on the both ends (staying form). Alternatively, the resin composition R in the liquid region R3 partially spreads beyond the high viscosity regions R1, R2 (flowing form). However, even in the flowing form, a flowing distance of the resin composition R and the amount of the flowing resin composition R are suppressed to be small as compared to the case where the partial viscosity increasing step is not performed and the high viscosity regions R1, R2 are not provided. Since the width of the high viscosity region is small in the first part R1 on the side of the first wire portion 2 and large in the second part R2 on the side of the second wire portion 3, the outflow of the resin composition R from the liquid region R3 beyond the high viscosity region is more likely to occur in the first part R1, and may or may not occur in the second part R2. In the shown form, the resin composition R in the liquid region R3 flowed beyond the first part R1 of the high viscosity region forms a fluid portion R4 outside the high viscosity region R1 along the axial direction.

To highly suppress the outflow of the resin composition R to the outside of the sheet body 7 in the surrounding step, parameters involved in forming the waterproof portion 6 may be so adjusted that the resin composition R hardly flows or the resin composition R hardly flows out to the outside of the sheet body 7 even if the resin composition R flows. For example, the parameters may be adjusted, such as by increasing the viscosity of the resin composition R in the high viscosity regions R1, R2, increasing the areas occupied by the high viscosity regions R1, R2, increasing the area of the sheet body 7 or gently performing the operation of squeezing the sheet body 7.

### (vi) Curing Step

Finally, the curing step is performed to cure the resin composition R surrounded by the sheet body 7. At this time, the entire resin composition R, i.e. both the resin composition R present in the liquid region R3 including the fluid portion R4 and the resin composition R present in the high viscosity regions R1, R2 and already in the semi-cured state are cured into a solid state. At this time, a curing operation may be performed according to the curability of the resin composition R. Also in the previous partial viscosity increasing step, the operation for curing the resin composition R was performed and a similar operation may be performed also in this curing step, but conditions for curing need to be so set that a degree of curing of the resin composition R is advanced in the entire region and the resin material in the solid state can be obtained. If the resin composition R is photo-curable, light may be irradiated to the entire region of the resin composition R, i.e. with the mask member M removed, by the light source device S. Since the sheet body 7 is light-transmissive, the resin composition R surrounded by the sheet body 7 can be cured if light is irradiated from the outside of the sheet body 7. At this time, the cumulative light amount per unit area is made larger than in the previous partial viscosity increasing step, the curing of the resin composition R in the high viscosity regions R1, R2 already in the semi-cured state is further advanced to set the resin composition R in the solid state, and the liquid resin composition R derived from the liquid region R3 is also cured into the solid state.

By way of this curing step, the wiring harness 1 is obtained in which the region including the covering portion 22 and the exposed portion 21 of the first wire portion 2, the splice portion 5 and the covering portion 32 and the exposed portion 31 of the second wire portion 3 is covered by the waterproof portion 6 and the outer periphery of the waterproof portion 6 is further protected by the sheet body 7. Since the outflow of the resin composition R to the outside of the sheet body 7 is suppressed in the surrounding step, the waterproof portion 6 is formed as the one entirely accommodated in the space surrounded by the sheet body 7 by way of the curing step. Alternatively, even if the waterproof portion 6 is not surrounded by the sheet body 7 in some locations, a volume of such locations is suppressed to be small. The curing step is preferably performed immediately after the completion of the surrounding step so that the outflow of the resin composition R in the liquid region R3 spread in the previous surrounding step does not advance. In the curing step, if the resin composition R is completely cured, the parts, which were the high viscosity regions R1, R2, the part, which was the liquid region R3, and the part, which was the fluid portion R4, before curing have a similar appearance except differences in surface smoothness to be described later, and interfaces therebetween become substantially unidentifiable.

As described above, both a case where the resin composition R in the liquid region R3 is in the staying form to remain in the space between the high viscosity regions R1 and R2 on the both ends and a case where the resin composition R in the liquid region R3 is in the flowing form by partially spreading beyond the high viscosity region R1 are possible in the surrounding step. In the case of the staying form, the total amount of the resin composition R remains in the region where the resin composition R was initially arranged in the resin arranging step. In that entire region, the resin composition R is cured in the partial viscosity increasing step and the curing step to become the waterproof portion 6 while keeping an initial state held in close contact with the surface of the sheet body 7. Thus, the surface of the formed waterproof portion 6 is cured in the entire region with a fine uneven structure of the surface of the sheet body 7 transferred thereto, and smoothness is reduced.

On the other hand, if the resin composition R is not in the staying form, but in the flowing form, the fluid portion R4 made of the resin composition R spread beyond the high viscosity region R1 from the liquid region R3 is cured in the curing step outside the region having the resin composition R arranged therein in the resin arranging step. Since the resin composition R in this fluid portion R4 is cured in a state not sufficiently spreading to the surface of the sheet body 7, curing progresses in a state where the resin composition R is not held in close contact with the sheet body 7 very much. Thus, the surface of the cured resin material is hardly affected by the uneven structure of the sheet body 7 and the liquid resin composition R is cured in a state where a smooth surface specific to the liquid is exposed. The region produced by curing this fluid portion R4 and having the exposed smooth surface becomes the end region 61. On the other hand, the location, which was initially the high viscosity regions R1, R2 and the liquid region R3, adjacent to the end region 61 is cured while keeping the initial state held in close contact with the surface of the sheet body 7, as in the case of the above staying form. Thus, this location becomes the adjacent region 62 with the surface having a low smoothness obtained by transferring the uneven structure of the sheet body 7. As just described, the waterproof portion 6 including the end region 61 having a high surface smoothness and the adjacent region 62 having a low surface smoothness is formed by way of the flowing form, and the wiring harness 1 according to the embodiment described above is obtained. In both the wiring harness 1 manufactured by way of the staying form and the wiring harness manufactured by way of the flowing form, the leakage of the resin material to the outside of the sheet body 7 is suppressed and high waterproofness is provided.

### <Relationship of Structure of Waterproof Portion and Manufacturing Method>

As described above, in the manufacturing method of the wiring harness according to the embodiment of the present disclosure, both the suppression of the leakage of the resin composition R to the outside of the sheet body 7 and high waterproofness are achieved by applying the partial semi-curing method including the partial viscosity increasing step. High waterproofness is mainly obtained by the contribution of the resin composition R in the liquid region R3. By performing the surrounding step with the wire bundle of the first wire portion 2 held in contact with the liquid region R3 kept in a state where the resin composition R is highly fluid by way of the partial viscosity increasing step, the resin composition R keeping a high fluidity penetrates to the space between the respective wires 4 (conductors 41) without any gap in the exposed portion 21 of the wire bundle. By way of the curing step in this state, the waterproof portion 6 is obtained in which the space between the plurality of wires 4 constituting the wire bundle of the first wire portion 2 is filled by the resin material without any gap as shown in a section of FIG. 6D, and high waterproofness is provided. On the other hand, since the resin composition R has a certain degree of fluidity left in the high viscosity regions R1, R2, the resin composition R is held in close contact with the outer peripheries of the two wire portions 2, 3 and the splice portion 5 and waterproofness is exhibited by way of curing. Since the regions covered by the high viscosity regions R1, R2 do not have spaces to be densely filled with the resin material inside unlike the space between the plurality of wires 4 in the exposed portion 21 of the first wire portion 2, sufficient waterproofness is obtained if the outer peripheries are surrounded by the resin composition R increased in viscosity and covered by the resin material of the waterproof portion 6 with a certain degree of adhesion obtained by way of curing.

The suppression of the leakage of the resin composition R to the outside of the sheet body 7 is mainly achieved by forming the high viscosity regions R1, R2. This is because, by increasing the viscosity of the resin composition R arranged on the surface of the sheet body 7 to form the high viscosity regions R1, R2, the resin composition R constituting the high viscosity regions R1, R2 hardly flows even by way of the surrounding step. In addition, this is because, by sandwiching the liquid region R3 having a low viscosity between the high viscosity regions R1, R2, the high viscosity regions R1, R2 function as banks and obstacle the free flow of the resin composition R having a low viscosity in the liquid region R3 in the surrounding step. As described above, both the case where the resin composition R in the liquid region R3 is in the staying form by remaining between the high viscosity regions R1 and R2 and the case where the resin composition R in the liquid region R3 is in the flowing form by that resin composition R partially flowing beyond the high viscosity region R1, R2 and forming the fluid portion R4 are possible. In the case of the flowing form, the fluid portion R4 is cured, whereby the end region 61 having a higher surface smoothness than the adjacent region 62 is formed in the end part of the waterproof portion 6 on the side of the first wire portion 2 as shown in FIG. 6A.

As just described, the presence of the end region 61 in the waterproof portion 6 is an evidence showing that the waterproof portion 6 was manufactured by the partial semi-curing method by way of the partial viscosity increasing step. That is, the waterproof portion 6 including the end region 61 having a higher surface smoothness than the adjacent region 62 is an index indicating that the waterproof portion 6 was formed with the leakage of the resin composition R to the outside of the sheet body 7 reduced and has high waterproofness by the resin material being filled in the space between the wires 4 constituting the wire bundle without any gap. By reducing the leakage of the resin composition R to the outside of the sheet body 7, workability is hardly reduced due to the outflow of the liquid resin composition R to the outside of the sheet body 7 in a state during the manufacturing of the waterproof portion 6, particularly in the surrounding step. Further, influences such as unnecessary contact with an external object can be reduced which possibly occur when the resin material leaks to the outside of the sheet body 7 and is cured in the waterproof portion 6 obtained by curing the resin composition R.

In the surrounding step, if a phenomenon in which the resin composition R in the liquid region R3 flows beyond the high viscosity region R1, R2 to form the fluid portion R4 occurs only in the end part on the side of the first wire portion 2 provided with the first part R1 of the high viscosity region, but does not occur in the end part on the side of the second wire portion 3 provided with the second part R2, the end region 61 having a high surface smoothness is provided in the end part on the side of the first wire portion 2, out of the waterproof portion 6, and the entire other region, i.e. the continuous region including the splice portion 5 and extending from the covering portion 22 of the first wire portion 2 to the covering portion 32 of the second wire portion 3, becomes the adjacent region 62 having a relatively low surface smoothness as in the form shown in FIGS. 1 and 2. In this embodiment, since the second wire portion 3 includes only one wire 4, the liquid region R3 needs not be provided in a region closer to the second wire portion 3 than the splice portion 5 for the purpose of filling the resin composition R into narrow spaces and complicated spaces, and the entire region may be the high viscosity region (second part R2) as shown in FIG. 4A. In this case, the second part R2 can be formed to occupy a large area. Then, the areas occupied by the high viscosity regions R1, R2 increase and, on the other hand, the area occupied by the liquid region R3 decreases on the surface of the resin composition R, whereby the fluidity of the resin composition R can be highly suppressed. However, if the fluidity of the resin composition R can be sufficiently suppressed, the second part R2 of the high viscosity region may be formed to have a small area and the resin composition R in the liquid region R3 may be allowed to flow beyond the second part R2 in addition to the first part R1 to form a fluid portion R4 also on the side of the second wire portion 3. In that case, an end region 61 having a smoother surface than the adjacent region 62 is also formed in the end part of the waterproof portion 6 on the side of the second wire portion 3, similarly to the end region 61 on the side of the first wire portion 2. The adjacent region 62 is formed to occupy a region between two end regions 61.

As described above, the formation of the end region 61 having a smoother surface than the adjacent region 62 in the end part of the waterproof portion 6 is an evidence showing that the waterproof portion 6 was formed by the partial semi-curing method. In addition to that, the presence of this end region 61 itself also contributes to enhancing waterproofness by the waterproof portion 6. As described above, the end region 61 is formed by the fluid portion R4 made of the resin composition R flowed from the liquid region R3 beyond the high viscosity region R1 being cured without being strongly held in close contact with the sheet body 7. From this, the end region 61 has a lower adhesion to the sheet body 7 than the adjacent region 62. Thus, if the wiring harness 1 is bent at or near the location where the waterproof portion 6 is formed, peeling stress is hardly generated between the waterproof portion 6 and the sheet body 7 in the end region 61. Peeling between the sheet body 7 and the waterproof portion 6 caused by bending progresses from the end part of the waterproof portion 6. However, since peeling stress is hardly generated in the end region 61, peeling hardly occurs between the sheet body 7 and the waterproof portion 6 even upon receiving a dynamic load such as bending. Then, even in a situation receiving a dynamic load such as bending, high waterproofness by the waterproof portion can be maintained. In addition, since the end part of the waterproof portion 6 has a smooth surface, water droplets hardly adhere to the end part and, even if water droplets adhere, those water droplets hardly stay on the surface of the waterproof portion 6. Also in this respect, the presence of the end region 61 enhances a waterproof effect by the waterproof portion 6.

Further, the presence of the smooth end region 61 also functions to suppress the transfer of substances between the sheet body 7 and the waterproof portion 6. The transfer of substances between the sheet body 7 and the waterproof portion 6, including the transfer of the plasticizer from the sheet body 7 containing the plasticizer to the waterproof portion 6 containing no plasticizer or containing a lower concentration of the plasticizer than the sheet body 7, occurs via an adhesive location in which the sheet body 7 and the waterproof portion 6 strongly adhere to each other. However, since adhesive strength between the sheet body 7 and the waterproof portion 6 is low in the end region 61, if an area of a strongly adhered portion serving as a substance transfer path is suppressed to be small, the transfer of the substances such as the plasticizer is less likely to occur. In that way, the modification of the waterproof portion 6 and/or the sheet body 7 due to the transfer of the substances and a reduction in waterproofness associated therewith are suppressed, and a state having high waterproofness is maintained even after the use of the wiring harness 1 for a long time or in a high-temperature environment. For example, if the transfer of the plasticizer from the sheet body 7 to the waterproof portion 6 occurs, the adhesion of the resin material constituting the waterproof portion 6 to the sheet body 7 and the insulation coatings 42 of the wires 4 is reduced. This leads to a possibility of causing a reduction in waterproofness, but such a reduction in waterproofness is less likely to occur by suppressing the transfer of the plasticizer by the presence of the end region 61.

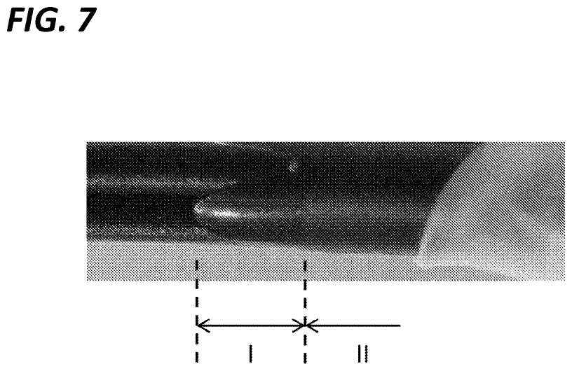

Actually, in the wiring harness 1 including the waterproof portion 6 formed by the partial semi-curing method, it is confirmed by an experiment that the leakage of the resin material from the sheet body 7 does not occur and the end region 61 having a higher surface smoothness than the adjacent region is formed in the end part of the waterproof portion 6. FIG. 7 shows an enlarged picture obtained by photographing the peeled sheet body 7 near the end part on the side of the first wire portion 2 for the waterproof portion 6 actually produced by the partial semi-curing method. At a position I of the end part, a region having higher glossiness than at a position II to the right of the position I is present. This region with high glossiness corresponds to the end region 61. The magnitude of glossiness indicates the level of surface smoothness. The wiring harness 1 including this waterproof portion 6 formed by the partial semi-curing method is confirmed to have high waterproofness both in an initial state immediately after the waterproof portion 6 was formed and in a state after the waterproof portion 6 was placed in a high-temperature environment.

In a method other than the partial semi-curing method, it is difficult to form the waterproof portion 6, in which the leakage of the resin material constituting the waterproof portion 6 to the outside of the sheet body 7 is suppressed, the space between the wires 4 is filled by the resin material without any gap in the exposed portion 21 of the first wire portion 2 and the end region 61 having a smooth surface is formed in the end part. For example, it is empirically confirmed that the waterproof portion 6 satisfying all of those features cannot be obtained in the case of forming the waterproof portion 6 by a one-stage curing method or an entire semi-curing method to be described below.

Further, a case where the waterproof portion 6 is formed by the one-stage curing method is described. In the one-stage curing method, the partial viscosity increasing step in the partial semi-curing method is not performed and the harness arranging step, the surrounding step and the curing step are performed with the entire region of the resin composition R arranged on the sheet surface in the resin arranging step kept in a liquid state. In this case, the resin composition R in a highly fluid state can penetrate to small spaces and complicated spaces between the constituent members of the wiring harness in the region where the waterproof portion 6 should be formed. Thus, as shown in FIG. 6E, a state where the resin material is filled in the space between the wires constituting the wire bundle without any gap is obtained. On the other hand, since the resin composition R has a high fluidity, the resin composition R easily flows out to the outside of the sheet body 7 in the surrounding step and is easily cured outside the sheet body 7 in that state in the surrounding step. Further, as shown in FIG. 6B, since the waterproof portion 6 is cured in a state held in close contact with the sheet body 7 in the entire region surrounded by the sheet body 7 including the end part, the surface of the waterproof portion 6 has a low smoothness by having the fine unevenness of the sheet body 7 transferred thereto. As a result, an effect of improving waterproofness by the presence of the smooth end region 61 is not obtained. Particularly, by way of a high-temperature environment, the waterproofness of the waterproof portion 6 is reduced due to the transfer of the plasticizer from the sheet body 7 to the waterproof portion 6. Also in an experiment, the waterproof portion 6 exhibited high waterproofness nearly equal to that when the partial semi-curing method was used in an initial state immediately after the waterproof portion 6 was formed, but waterproofness was notably reduced by way of the high-temperature environment.

Next, a case where the waterproof portion 6 is formed by the entire semi-curing method is described. In the entire semi-curing method, the viscosity of the entire region of the resin composition R arranged on the surface of the sheet body 7 in the resin arranging step is increased to obtain a viscous or gel-like substance, unlike an increase in the viscosity of the resin composition R only in the partial regions by performing the partial viscosity increasing step in the partial semi-curing method. If the resin composition R is photo-curable, the viscosity of the entire resin composition R can be increased by irradiating light without using the mask member M with a cumulative light amount suppressed to semi-cure the resin composition R without completely curing the resin composition R for the entire region. Thereafter, the harness arranging step, the surrounding step and the curing step are performed. In this case, since the surrounding step is performed in a state where the entire resin composition R is highly viscous, the leakage of the resin material to the outside of the sheet body 7 does not occur. Further, the highly viscous resin composition R slightly flows in the region surrounded by the sheet body 7 in the surrounding step, a part where the resin composition R flows is cured by the curing step without being held in close contact with the sheet body 7. Thus, as shown in FIG. 6C, a region having a higher surface smoothness than the adjacent region is formed in the end part of the waterproof portion 6. However, since the waterproof portion 6 is formed by bringing the location of the harness precursor 1′ including the exposed portion 21 of the wire bundle into contact with the resin composition R having a high viscosity and a reduced fluidity, the resin composition R cannot sufficiently penetrate to the region between the wires 4 constituting the wire bundle. As a result, as shown in a section of FIG. 6F, a gap V not filled by the resin material is formed between the wires 4 constituting the wire bundle. This gap V reduces the waterproofness of the waterproof portion 6. Also in an experiment, only low waterproofness was obtained from an initial state immediately after the waterproof portion 6 was formed, and that waterproofness was clearly poor as compared to the case of using the partial semi-curing method. Also in the case of the resin composition R having the viscosity increased by a method other than semi-curing by light irradiation or the like such as the addition of a thickening agent or a gelling agent, the waterproof portion 6 similarly includes a region having a higher surface smoothness in the end part and, on the other hand, the gap V not filled by the resin material is easily formed between the wires 4 constituting the wire bundle.

### <Other Forms>

In the wiring harness 1 described above, the splice portion 5 is configured as an intermediate splice portion and the first wire portion 2 constituted by the wire bundle including the plurality of wires 4 and the second wire portion 3 including only one wire 4 are provided on the both sides of the splice portion 5. However, the wiring harness of the present disclosure is not limited to this form. In a wiring harness provided with a wire bundle including a plurality of wires, a splice portion, a waterproof portion and a sheet body, the splice portion may join the wires constituting the wire bundle to each other in an exposed portion, the waterproof portion may cover the splice portion and the exposed portion and a covering portion of the wire bundle by a curable resin material, and the sheet body may surround the outer periphery of the waterproof portion. The waterproof portion may fill a space between the plurality of wires constituting the wire bundle without any gap by the resin material in the exposed portion, further include a partial region including an end part as an end region and a region adjacent to the end region as an adjacent region, out of a region surrounded by the sheet body and covering the covering portion along an axial direction of the wire bundle, and have a smoother surface in the end region than in the adjacent region.

For example, if the splice portion 5 is in the form of an intermediate splice portion, the second wire portion 3 may also be configured as a wire bundle including a plurality of wires 4, similarly to the first wire portion 2. In that case, the waterproof portion 6 preferably fills a space between the wires 4 constituting the wire bundle without any gap by the resin material not only in the exposed portion 21 of the first wire portion 2, but also in the exposed portion 31 of the second wire portion 3. Further, the waterproof portion 6 preferably includes the end region 61 not only in the region including the end part on the side of the first wire portion 2, but also in the region including the end part on the side of the second wire portion 3, and both of those end regions 61 on the both ends preferably have a smoother surface than the adjacent region 62 occupying the region therebetween. To form the waterproof portion 6 including the end region 61 also on the side of the second wire portion 3 in that way, the second part R2 of the high viscosity region may be provided in a region corresponding to a part of the covering portion 32 of the second wire portion 3 of the harness precursor 1′, in particular at a position slightly separated toward the covering portion 32 from a boundary between the exposed portion 31 and the covering portion 32 of the second wire portion 3, similarly to the first part R1, in the partial viscosity increasing step. The entire region between those first and second parts R1, R2 of the high viscosity regions may be the liquid region R3.

Further, the splice portion may not necessarily be formed as an intermediate splice portion including the first wire portion 2 and the second wire portion 3 on the both ends. For example, it is also thought to form a splice portion on the end part of the wire bundle formed by bundling the plurality of wires 4 and arrange the waterproof portion 6 and the sheet body 7 on the outer periphery of that splice portion.

Further, in the wiring harness 1 described above, the form in which the entire region of the waterproof portion 6 is accommodated inside the region surrounded by the sheet body 7 is mainly described. However, there is no particular limitation to such a form, and a partial region of the waterproof portion 6 may be formed to come out from the region surrounded by the sheet body 7. For example, the resin composition constituting the waterproof portion 6 may leak out in a partial region along the outer periphery of the covering portion 22 of the first wire portion 2 configured as the wire bundle, out of the end part of the entire waterproof portion 6. Even in such a case, an end part of the region surrounded by the sheet body 7 and covering the covering portion 22 of the first wire portion 2, i.e. a region excluding a part coming out from the sheet body 7, out of the waterproof portion 6, may be set as the end region 61, and that end region 61 may have a smoother surface than the adjacent region 62 (region adjacent to the end region 62, out of the region surrounded by the sheet body 7 and covering the covering portion 22 of the first wire portion 2). As just described, a structure in which the waterproof portion 6 partially comes out from the sheet body 7 can also be formed by the partial semi-curing method described above. Such a structure is formed if a part of the fluid portion R4 flows out to the outside of the sheet body 7 in the surrounding step. As just described, even if the resin composition constituting the waterproof portion 6 partially leaks to the outside of the region surrounded by the sheet body 7, the leakage of the resin composition constituting the waterproof portion 6 from the sheet body 7 is reduced and high waterproofness is ensured by adopting the partial semi-curing method as compared to the case of using the one-stage curing method. However, a location where the leakage of the resin composition constituting the waterproof portion 6 to the outside of the sheet body 7 does not occur is preferably present at least in a partial region along the outer periphery of the covering portion 22 of the first wire portion 2 in the formed waterproof portion 6.

Although the embodiment of the present disclosure has been described in detail above, the present invention is not limited to the above embodiment at all and various changes can be made without departing from the gist of the present invention.

### LIST OF REFERENCE NUMERALS

1 wiring harness
1′ harness precursor
2 first wire portion
21 exposed portion of first wire portion
22 covering portion of first wire portion
3 second wire portion
31 exposed portion of second wire portion
32 covering portion of second wire portion
4 wire
41 conductor
41a strand
42 insulation coating
5 splice portion
6 waterproof portion
61 end region
62 adjacent region
7 sheet body
M mask member
N nozzle
R uncured resin composition
R1 first part of high viscosity region
R2 second part of high viscosity region
R3 liquid region
R4 fluid portion
S light source device
V gap

1. A wiring harness, comprising a wire bundle, a splice portion, a waterproof portion and a sheet body,
the wire bundle including a plurality of wires,
the wire including a conductor and an insulation coating covering an outer periphery of the conductor,
the wire bundle including an exposed portion where the conductors are exposed from the insulation coatings of the wires and a covering portion adjacent to the exposed portion, the conductors being covered by the insulation coatings in the covering portion,
the splice portion joining the wires constituting the wire bundle to each other in the exposed portion,
the waterproof portion covering the splice portion, the exposed portion and the covering portion by a curable resin material,
the sheet body surrounding an outer periphery of the waterproof portion,
the waterproof portion filling a space between the plurality of wires constituting the wire bundle without any gap by the resin material in the exposed portion,
the waterproof portion including a partial region having an end part as an end region and a region adjacent to the end region as an adjacent region, out of a region surrounded by the sheet body and covering the covering portion along an axial direction of the wire bundle, the waterproof portion having a smoother surface in the end region than in the adjacent region, and
the waterproof portion being held in close contact with an outer periphery of the wire bundle or the splice portion in the entire adjacent region.

2. The wiring harness of claim 1, wherein the waterproof portion is entirely accommodated inside the region surrounded by the sheet body.

3. The wiring harness of claim 1, wherein:
the sheet body is made of a resin material containing a plasticizer, and
the resin material constituting the waterproof portion either contains no plasticizer or contains a plasticizer at a lower concentration than the sheet body.

4. The wiring harness of claim 1, wherein, in the waterproof portion, the adjacent region continuously extends at least to a region covering the splice portion and the end region has a smoother surface than the entire adjacent region.

5. The wiring harness of claim 4, wherein:
the wiring harness includes the splice portion as an intermediate splice portion in a midway part in the axial direction and includes the wire bundle as a first wire portion on one side of the splice portion along the axial direction and a second wire portion having one or more wires on the other side, and
the waterproof portion covers a region from the covering portion of the first wire portion to the covering portion of the second wire portion and includes the end region at least in a partial region including an end part on the side of the first wire portion.

6. A wiring harness manufacturing method, comprising:
a joining step of forming a wire bundle by bundling a plurality of wires each including a conductor and an insulation coating covering an outer periphery of the conductor after the insulation coatings in a partial region are removed, the wire bundle including an exposed portion where the conductors are exposed and a covering portion adjacent to the exposed portion, the conductors being covered by the insulation coatings in the covering portion, forming a splice portion by joining the wires to each other in the exposed portion and fabricating a harness precursor;
a resin arranging step of arranging a curable liquid resin composition in a partial region of a surface of a sheet body,
a partial viscosity increasing step of increasing a viscosity of the resin composition arranged on the surface of the sheet body only in a partial region to form a high viscosity region and leave a region other than the high viscosity region as a liquid region;
a harness arranging step of arranging a part including the splice portion of the harness precursor on a surface of the resin composition so that the exposed portion of the wire bundle contacts the liquid region;
a surrounding step of surrounding the harness precursor by the surface of the sheet body having the resin composition arranged thereon; and
a curing step of curing the resin composition surrounded by the sheet body in an entire region,
the joining step, the resin arranging step, the partial viscosity increasing step, the harness arranging step, the surrounding step and the curing step being performed in this order, and
in the partial viscosity increasing step, the high viscosity regions being provided as regions in a semi-cured state where the resin composition is viscous although being increased in viscosity and the fluidity thereof is not completely lost in a first part and a second part respectively including one end part and another end part and separated from each other along an axial direction of the harness precursor, out of the region where the resin composition is arranged, and the liquid region being provided between the first part and the second part to include a region where the exposed portion of the wire bundle is arranged.

7. The wiring harness manufacturing method of claim 6, wherein:
the resin composition is photo-curable,
the sheet body is transmissive to light capable of curing the resin composition,
light is irradiated to the resin composition with a region to be set as the liquid region, out of the resin composition arranged on the surface of the sheet body, covered by a mask member for blocking the light in the partial viscosity increasing step, whereby the resin composition is semi-cured in the high viscosity regions, and
light is irradiated to the entire region of the resin composition to cure the resin composition from outside of the sheet body surrounding the harness precursor in the curing step.

8. The wiring harness manufacturing method of claim 6, wherein:
the sheet body is made of a resin material containing a plasticizer, and
the resin composition either contains no plasticizer or contains a plasticizer at a lower concentration than the sheet body.

9. The wiring harness manufacturing method of claim 6, wherein:
the harness precursor includes the splice portion as an intermediate splice portion in a midway part in the axial direction and includes the wire bundle as a first wire portion on one side of the splice portion along the axial direction and a second wire portion having one or more wires on the other side,
the resin composition is continuously arranged at a position corresponding to a region from the covering portion of the first wire portion to the covering portion of the second wire portion of the harness precursor in the resin arranging step, and
the first part is provided in a region corresponding to a part of the covering portion of the first wire portion and the second part is provided to include a region corresponding to a part of the covering portion of the second wire portion as the high viscosity regions in the partial viscosity increasing step.

10. The wiring harness manufacturing method of claim 9, wherein:
the second wire portion includes only one wire, and
the second part is continuously provided in a region corresponding to a location from the splice portion to the covering portion of the second wire portion in the partial viscosity increasing step.

11. A wiring harness manufactured by the wiring harness manufacturing method of claim 6.
